(19) United States
(12) Patent Application Publication
(10) Pub. No.: US 2026/0086907 A1
(43) Pub. Date: Mar. 26, 2026

(54) ARTIFICIAL INTELLIGENCE BASED AUTOMATED TESTING AND EARLY FAILURE PREDICTION SYSTEM AND METHOD THEREOF

(71) Applicant: L&T TECHNOLOGY SERVICES LIMITED, Chennai (IN)

(72) Inventors: VASIMUDDIN SAIFUDDIN SHAIKH, Thane (IN); DEVASEELAN ALAGAR, Chennai (IN); SAURABH BHALCHANDRA PANDIT, Thane (IN)

(21) Appl. No.: 19/059,379

(22) Filed: Feb. 21, 2025

(30) Foreign Application Priority Data
Sep. 20, 2024 (IN) 202441071149

(51) Int. Cl. G06F 11/277; G06F 11/22

(52) U.S. Cl. CPC G06F 11/277; G06F 11/2263

(57) ABSTRACT

The present invention describes system for facilitating testing of a System under Test (SUT). The system comprises a control unit configured to dynamically assign at least one hardware configuration to each of the one or more devices based on SUT information. Further, the control unit is configured to create at least one device classification group to include the one or more devices based on the assigned configuration, and generate a test template for each of the generated at least one device classification group based on the SUT information. Finally, the control unit is configured to perform testing, during real time operation, on the one or more devices associated with the SUT present within the at least one device classification group, based on the generated test template, test sequence, and the assigned hardware configuration to determine health status of the one or more devices.

### CROSS-REFERENCE TO RELATED APPLICATIONS

This application is a Non-Provisional application, which claims priority to the Indian non-provisional patent application No. 202441071149, filed Sep. 20, 2024, entitled “ARTIFICIAL INTELLIGENCE BASED AUTOMATED TESTING AND EARLY FAILURE PREDICTION SYSTEM AND METHOD THEREOF”, which is hereby incorporated by reference in its entirety.

### DESCRIPTION

### Technical Field

The present invention generally relates to the field of artificial intelligence (AI) based on automated testing of the System under Test (SUT).

### Background

The following description includes information that may be useful in understanding the present invention. It is not an admission that any of the information provided herein is prior art or relevant to the presently claimed invention, or that any publication specifically or implicitly referenced is prior art.

Testing is an essential requirement for validating whether a product (e.g software, hardware etc.) is meeting the established standards before deployment or sometimes before manufacturing. For example, the testing system that performs software testing is used to verify whether the embedded software and firmware are capable of providing intended functionality correctly, optimally, and is free of bugs. Similarly, the testing system that performs hardware testing assesses the physical components of hardware devices, including circuit boards, sensors, and connectors, to evaluate their functionality and performance.

Conventional testing systems that perform hardware testing typically involves a dedicated software system that is specifically designed to test a particular type of hardware device. Each application is hardcoded to interact with a defined set of inputs and outputs tailored to the specifications of the device being tested. For example, if a device has five digital inputs and five analog outputs, the testing software will be programmed to manage and analyze these specific connections.

Conventional testing systems for hardware devices typically rely on specialized software that is hard-coded to work with specific hardware configurations. This results in a lack of flexibility, as each application is designed for a particular device type. When a new device with a different configuration needs testing, the existing software must either be modified or a completely new application is developed to cater the testing need. This approach is time-consuming and costly, as it requires a lot of development effort and resources to modify or create new software.

As a result, there is a need for a solution to cater testing need of all type of hardware devices.

### SUMMARY OF THE DISCLOSURE

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In an aspect, the present disclosure recites a system for facilitating testing of a System under Test (SUT). The system comprises a user interface and a control unit communicably coupled with the user interface. The control unit is configured to receive SUT information of each of one or more devices associated with the SUT. The SUT information comprises component information and operational characteristics of the one or more devices. The control unit is further configured to dynamically assign, by a pre-trained machine learning (ML) model, at least one hardware configuration to each of the one or more devices based on the SUT information, create, by the pre-trained ML model, at least one device classification group to include the one or more devices based on the assigned configuration, and generate, by the pre-trained ML model, a test template for each of the generated at least one device classification group based on the SUT information. The test template include a sequence of operations to be performed on the one or more devices. After generating the test template, the control unit is configured to identify, by the pre-trained ML model, a test sequence for each of the generated at least one device classification group. The test sequence is indicative of an order in which testing on the generated at least one device classification group is to be performed. Finally, the control unit is configured to perform, by the pre-trained ML model, testing, during real time operation, on the one or more devices associated with the SUT within the at least one device classification group, based on the generated test template, identified test sequence, and the assigned hardware configuration to determine health status of the one or more devices.

In an aspect, the present disclosure recites a method for facilitating testing of a System under Test (SUT). The method includes receiving SUT information of each of one or more devices associated with the SUT. The SUT information comprises component information and operational characteristics of the one or more devices. Sequentially the method includes dynamically assigning at least one hardware configuration to each of the one or more devices based on the SUT information, creating at least one device classification group to include the one or more devices based on the assigned configuration, generate a test template for each of the generated at least one device classification group based on the SUT information. The test template include a sequence of operations to be performed on the one or more devices. After generating the test template, the method includes identifying a test sequence for each of the generated at least one device classification group. The test sequence is indicative of an order in which testing on the generated at least one device classification group is to be performed. Finally, the method include performing testing, during real time operation, of the one or more devices associated with the SUT within the at least one device classification group, based on the generated test template, identified test sequence, and the assigned hardware configuration to determine health status of the one or more devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates an environment architecture of a system for facilitating testing of a system under test (SUT), in accordance with an embodiment of the present disclosure.

FIG. 2 illustrates a system for facilitating testing of the one or more devices, in accordance with an embodiment of the present disclosure.

FIG. 3 illustrates a system for facilitating training of the ML model, in accordance with an embodiment of the present disclosure.

FIG. 4 depicts a flow diagram of a method for facilitating testing of a System under Test (SUT), in accordance with an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

Various embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements.

The term “or” is used herein in both the alternative and conjunctive sense, unless otherwise indicated.

The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations.

If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The phrase “artificial intelligence” refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

The phrase “machine learning” is used throughout the disclosure. The machine learning broadly describes a function of systems that learn from data. A machine learning system, engine, or module can include a machine learning algorithm that can be trained to learn functional relationships between inputs and outputs that are currently unknown. In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs.

Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. Unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Turning now to the drawings, the detailed description set forth below in connection with the appended drawings is intended as a description of various configurations and is not intended to represent the only configurations in which the concepts described herein may be practiced. The detailed description includes specific details for the purpose of providing a thorough understanding of various concepts with like numerals denote like components throughout the several views. However, it will be apparent to those skilled in the art that these concepts may be practiced without these specific details.

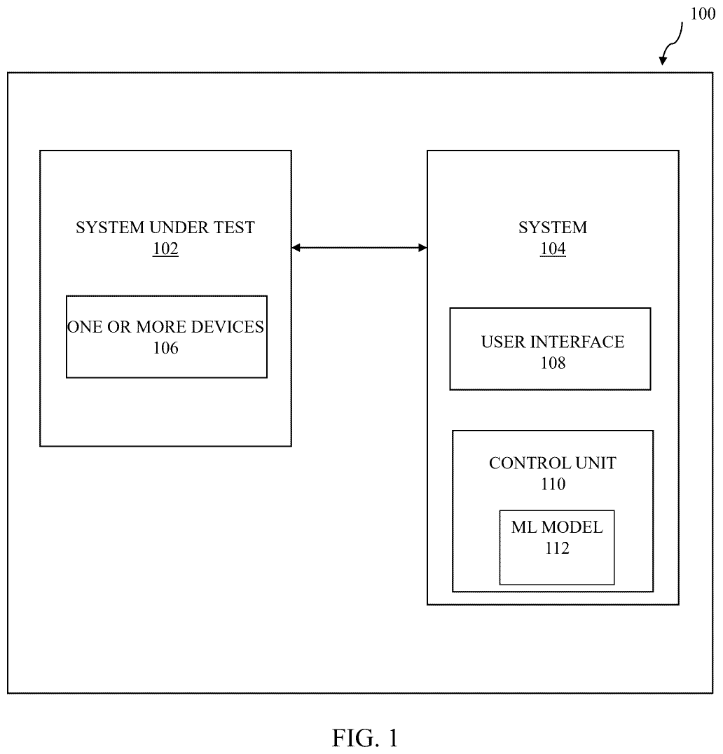

FIG. 1 illustrates an environment architecture 100 of a system for facilitating testing of a System under Test (SUT), in accordance with an embodiment of the present disclosure. The environment architecture 100 may be constituted by the SUT 102 and the system 104. All the constituent elements of the environment architecture 100 illustrated in FIG. 1 are essential constituent elements, however the environment architecture 100 may be implemented by more constituent elements than the constituent elements illustrated in FIG. 1. However, the same are not explained for the sake of brevity.

In an embodiment, the SUT 102 may refer to one or more devices 106 on which testing is to be performed by the system 104 during the run time of the one or more devices 106. For example, the one or more devices 106 may be, not limited to, a fan, contactor, strain gauge, and so on.

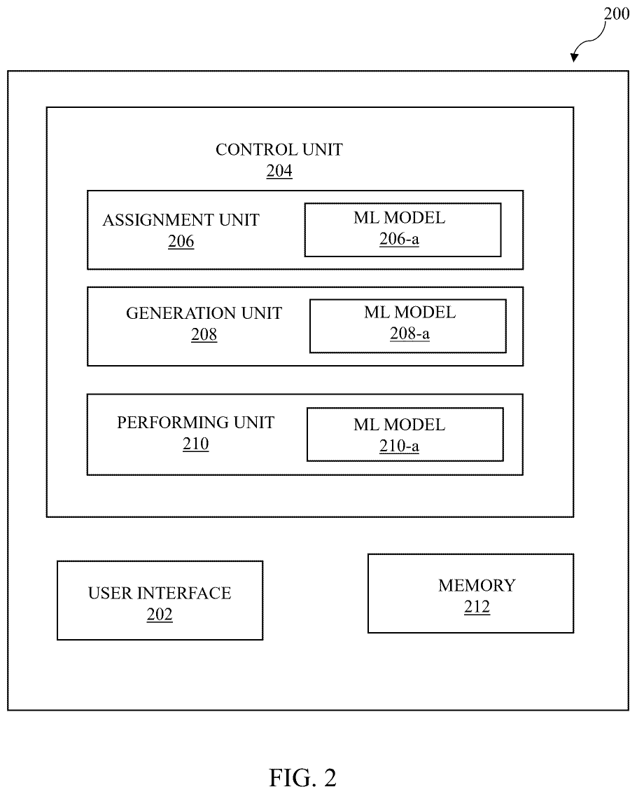

In an embodiment, the system 104 may constitute a user interface 108 and a control unit 110. In an embodiment, the control unit 110 may comprises an ML model 112. It may be noted, all the elements included in the system 104 illustrated in FIG. 1 are essential elements, however the system 104 may comprise more elements than the elements illustrated in FIG. 1 and the same are not explained for the sake of brevity. Further, all the elements of the system 104 may communicate with each other via wireless/wired communication network. The detailed functioning of the system 104 is further explained in FIG. 2 in forthcoming paragraphs of the present disclosure.

In an exemplary embodiment, the system 104 may be implemented in a variety of computing systems, such as a laptop computer, a desktop computer, a notebook, a server, a network server, a cloud-based server and the like.

Moving towards FIG. 2 that illustrates a system 200 for facilitating testing of the SUT 102 (i.e. for one or more devices 106 present in SUT 102), in accordance with an embodiment of the present disclosure.

According to an embodiment of the present disclosure, the system 200 (same as the system 104 of FIG. 1) may be constituted by a user interface 202 (same as the user interface 108 of FIG. 1), a control unit 204 (same as the control unit 110 of FIG. 1), and a memory 212. All the elements of the system 200 illustrated in FIG. 2 are essential elements, and the system 200 may be implemented by more elements than the elements illustrated in FIG. 2, however the same are not explained for the sake of brevity. All the elements of the system 200 may communicate with each other via wireless connection, electric connection, or combination of both.

In an embodiment, the user interface 202 may be an interface that allows the system 200 to receive and transmit information of the one or more devices 106. In an exemplary embodiment, the user interface 202 may be configured to receive user input based on user operation on the user interface 202.

In an embodiment, to perform hardware testing on one or more devices 106, a user may first check whether the predefined list includes the required tests for one or more devices 106. If the predefined list includes a test for at least one device, the user may select a test for at least one device from the predefined list. For remaining devices, the user may manually create a test entry by entering the test name in a new test window associated with the user interface 202. After entering the test name, the user may provide the SUT information for the remaining devices.

In a non-limiting example of the present disclosure, the user needs to test a BLDC fan, a strain gauge, and an XY component. If the predefined list includes a test for the XY component but not for BLDC fan and strain gauge, the user can select the test for XY component from the list. However, since test related to the BLDC fan and the strain gauge are not included in the predefined list, the user must manually create test entries for these devices. The user opens a new test window associated with the user interface 202 and manually enters the test names for the BLDC fan and the strain gauge. After entering the test names, the user then provides the SUT information for these devices.

In an embodiment, the SUT information may comprise component information and operational characteristics of the one or more devices 106. The component information may refer to the specific details about the individual parts or elements of one or more devices 106 that are involved in testing operation. This information may include the type of input and output connections, the function of each component present in the one or more devices, and their configurations, such as names, pin assignments, and operational ranges. The operational characteristics may refer to the specific performance metrics and behaviours of the one or more devices 106 during its operation. These characteristics may provide insight into how the one or more devices 106 functions under various conditions, including type of input required, and operational limits (e.g., pressure, temperature, voltage etc).

In a non-limiting example of the present disclosure, the one or more devices 106 may be the BLDC Fan and the Strain Guage. The component information of the BLDC fan and strain gauge may be considered as described in Table 1 and Table 2, respectively.

TABLE 1

| | Component/Parameter | |
|---|---|---|
| S. No. | Name | Type |
| 1 | Input Voltage | Analog Voltage |
| 2 | Tachometer | Digital Waveform Frequency |
| 3 | Vibration | Vibration |
| 4 | Thermocouple | Temperature |
| 5 | Static Pressure | Analog Voltage |

TABLE 2

| S. NO. | Component Name | Type |
|---|---|---|
| 1 | Strain gauge | strain |

After receiving the SUT information for the one or more devices 106, either by selecting from a predefined list or by manually inputting the information, the user may provide details on quantity of each device of the one or more devices 106 to be tested. In a non-limiting example of the present disclosure, if the user wishes to test 10 BLDC fans and 5 strain gauges, the user may input the number of devices using the hardware selection window associated with the user interface 202.

After selecting the quantity of each of the one or more devices 106, the user interface 202 may provide the control unit 204 with information regarding the quantity of each device, along with their components and operational characteristics.

In an embodiment, after receiving the above information, an assignment unit 206 of the control unit 204 may be configured to assign calibration and scaling factors to at least one parameter associated with SUT information of the one or more devices 106. In order to assign calibration and scaling factors, the assignment unit 206 may use a pre-trained ML model (i.e., an ML model 206-a). This assignment is based on the device-specific characteristics, such as sensor type, measurement range, and output format. The calibration and scaling factor enables transformation of the at least one parameter from one format to another format in order to accommodate scaling and calibration applied on the at least one parameter.

In particular, the calibration and scaling factors may be assigned using a lookup table, a multi-point conversion factor, or a simple equation. The lookup table provides a direct mapping between the input values and the corresponding output values, while the multi-point conversion factor allows for different conversion factors to be applied to different ranges of input values. The simple equation provides a mathematical relationship between the input and output values.

The ML model 206-a may apply the assigned calibration and scaling factors to transform the at least one parameter. This transformation enables the comparison of the measured values with the expected values.

In a non-limiting example of the present disclosure, a pressure sensor that outputs a voltage signal in millivolts (mV). The ML model 206-a may convert this voltage signal to a pressure value in bars. The sensor measurement range is from 0 to 100 mV, and the corresponding pressure range is from 0 to 100 bar.

In a scenario, the calibration and scaling factors may be represented by a lookup table that maps input voltage values to the corresponding pressure values, as shown in Table 3.

TABLE 3

| Input Voltage (mV) | Output Pressure (bar) |
|---|---|
| 0 | 0 |
| 10 | 20 |
| 20 | 40 |
| 30 | 60 |
| 40 | 80 |
| 50 | 100 |

In an another scenario, the calibration and scaling factor may be a multi-point conversion factor, where different conversion factors are applied to different ranges of input values. For example:
For input values between 0 and 20 mV, the conversion factor is 2 (i.e., 1 mV=2 bar)
For input values between 20 and 40 mV, the conversion factor is 4 (i.e., 1 mV=4 bar)
For input values between 40 and 60 mV, the conversion factor is 6 (i.e., 1 mV=6 bar)

In an another scenario, the calibration and scaling factor may be derived from mathematical equations, such as:

$$Pressure ( bar ) = ( Input Voltage ( mV ) / 10 ) + 5$$

The transformed values are then used for further analysis, such as for comparison with expected values, for calculation of performance metrics, or visualization of results.

In an embodiment, after receiving the information regarding the quantity of each device, along with their components and operational characteristics the, the assignment unit 206 may be configured to rename the number of one or more devices. For example, if 3 BLDC fan are selected for the test, the assignment unit 206 may be configured to rename a first BLDC fan as BLDC-1, a second BLDC fan as BLDC-2, and a third BLDC fan as BLDC-3.

After performing the renaming of the one or more devices 106, the assignment unit 206 may be configured to assign one hardware configuration to each of the one or more devices 106 based on the SUT information. In an embodiment, the assignment of the hardware configuration and assignment of the calibration and conversion factor may be performed parallelly. In another embodiment, the assignment of the hardware configuration and assignment of the calibration and conversion factor may be performed sequentially.

In order to assign hardware configuration, the assignment unit 206 may use the ML model 206-a. In particular, the ML model 206-a may be configured to compare the SUT information of each of the one or more devices 106 with predefined information stored in a memory 212 of the system 200. In an embodiment, the memory 212 may include three primary categories of information: (1) component information, (2) operational characteristics, and (3) one or more hardware configurations that are available. In an embodiment, the component information may indicates various physical and functional components of multiple devices. In an embodiment, the operational characteristics may indicates how the multiple devices operates under various conditions, including parameters such as input/output configurations, voltage ranges, and performance metrics. In an embodiment, one or more hardware configuration defines the hardware pins or connections that are currently available within the system 200. In a non-limiting example of the present disclosure, the system 200 includes five pins, there may be instances where only three pins are available for assignment as remaining two pins are already allocated to other devices.

In the comparing process, the ML model 206-a may compare the SUT information with the predefined information available to identify correlation between the two and determine the most suitable hardware configuration available for the one or more devices 106. After determining the most suitable hardware configuration, the ML model 206-a may assign the hardware configuration to each of the one or more devices 106.

In a non-limiting example of the present disclosure, one of the one or more devices 106 may be the BLDC fan and the Strain Gauge. The ML model 206-a may compare the SUT information of the BLDC fan against the predefined information (e.g. historical information available with the system) and assign hardware configuration to the BLDC fan and the strain gauge as shown below in table 4 and table 5 respectively:

TABLE 4

| | | Assignment of hardware | | |
|---|---|---|---|---|
| component information | | configuration | | |
| of BLDC fan | | data acquisition | | |
| Name | Renamed | card | pins | configuration |
| Input | BLDC Fan 1: | PXIe-6363 | AI0 | −5 V to 5 V |
| Voltage | Input Voltage | | | |
| Tachometer | BLDC Fan1: | PXIe-6363 | Ctr0 | 0 V to 5 V |
| | Tachometer | | | 100 MHz |
| | | | | Base Clock |
| Vibration | BLDC Fan1: | PXIe-4464 | AI0 | −5 V to 5 V |
| | Vibration | | | |

TABLE 5

| | | Assignment of hardware | | |
|---|---|---|---|---|
| component information | | configuration | | |
| of Strain Gauge | | data acquisition | | |
| Name | Renamed | card | pins | configuration |
| Strain Guage | Strain Gauge 1 | PXIe-4330 | AI0 | −100 mV to |
| | | | | 100 mV |

In an embodiment, after assigning the pin, the user interface 202 may be configured to display a window showing the hardware configuration assignment. Additionally, the user interface 202 may provide the user with the option to change the assigned pin through manual intervention by selecting the hardware configuration from the predefined list.

In an embodiment, after assigning the hardware configuration to each of the one or more devices 106, the assignment unit 206 may provide the assignment information to a generation unit 208 of the control unit 204. The generation unit 208 may use the pre-trained ML model 208-a (i.e., an ML model 208-a) to perform the operation related to device classification of the one or more devices 106.

In an embodiment, the ML model 208-a may be configured to classify/create the one or more devices 106 into different groups based on a user input received via the user interface 202 and/or the assigned configuration. After classifying the one or more devices 106 into different groups, the ML model 208-a may be configured to generate a test template for each of the different groups based on the device classification. The test template may include a sequence of operations to be performed on the one or more devices 106. After generating the test template, the ML model 208-a may be configured to identify an order (as a test sequence) in which testing of groups is to be performed. In an embodiment, the test template for the different group may be same or different depending on the assigned configuration.

In a non-limiting example of the present disclosure, there are 10 BLDC fans that need to be tested. The ML model 208-a may first classify these fans into two distinct groups based on their vendors and/or the assigned configuration. The assigned information may indicates first group that is designed with unique components that require specific tests for performance, while second group might have different specifications and operational characteristics than the first group. After classification, the ML model 208-a may generate a test template for first group and test template for the second group. Finally, the ML model 208-a may identify that the testing of the first group is performed later than the testing of the second group.

In another embodiment, the ML model 208-a may be configured to classify the one or more devices 106 into different groups based on the assigned configuration. After classifying the one or more devices 106 into different groups, the ML model 208-a may be configured to further classify at least one of different group into multi sub-groups based on a user input received by using the user interface 202 and/or assigned configuration. After performing the classification, the ML model 208-a may generate the test template for each of the different groups. The test template may include a sequence of operations to be performed on the devices. After generating the test template, the ML model 208-a may be configured to identify an order (as a test sequence) in which testing of the groups to be performed. In an embodiment, the test template for the corresponding multi sub-group, the sub-group may be same or different depending on the assigned configuration.

In a non-limiting example, there are three BLDC fans and ten strain gauges that need to be tested. The ML model 208-a may classify the three BLDC fans into a first group based assigned configurations and the ten strain gauges into a second group. The ML model 208-a may further identify, based on the assigned configuration (indicating that all three BLDC fans may require different test operations) or input information (i.e., all the BLDC fans are from different vendors), that it should not combine the BLDC fans into a single sub-group. Instead, the ML model 208-a may treat each BLDC fan as a separate sub-group within the first group. Furthermore, the ML model 208-a may create a test template for each of the BLDC fans present in the first group. The test template for each of the BLDC fan may be same or different. Further, the ML model 208-a may divide the second group (having strain gauges) into three sub-groups based on the assigned configurations/input information and create test template for each of the sub-groups. The test template for each of the sub-group may be same or different. Finally, the ML model 208-a may identifies the order (i.e., the testing sequence) is as follows: the three BLDC fans are tested first (in the order of Fan 1, Fan 2, and Fan 3), after which the strain gauges are tested, proceeding through the sub-groups in this order: first sub-group, second sub-group, and third sub-group.

After identifying the test template and the test sequence for the at least one device group, the generation unit 208 may provide the test template, the test sequence, and assigned information for the at least one device group to the performing unit 210. The performing unit 210 may use a pretrained ML model 210-a (i.e., an ML model 210-a) to perform the operation related to performing testing of the one or more devices 106 to determine health status of one or more devices.

In particular, the ML model 210-a may be configured to perform the testing of the one or more devices 106 based on the test sequence and the test template over a predefined period during run time of the one or more devices 106. The predefined period may be, not limited to, a day, a week, a month, and so on. After performing the testing of one or more devices 106, the ML model 210-a may be configured to generate the test results for the one or more devices 106. The ML model 210-a may compare the test result of one or more devices 106 with one or more test patterns pre-stored in the memory 212. If the test result of the one or more devices 106 do not match with the one or more pre-stored test patterns, the ML model 210-a may be configured to assign the health status for the one or more devices 106 as “unhealthy”. If the test result of test results of the one or more devices 106 match with the one or more prestored test patterns, the ML model 210-a may be configured to assign the health status for the one or more devices 106 as “healthy”.

In a non-limiting example of the present disclosure, the ML model 210-a may perform the testing of the BLDC fan at different RPMs (like 1000, 2000, and 3000 RPM) while measuring the temperature for 5 minutes at each RPM over a period of 10 to 15 days. The ML model 210-a compares the results of these tests with pre-stored patterns, which include expected temperature ranges for each RPM based on historical data or vendor specifications. If the measured temperature at any RPM exceeds the expected range, the model assigns the health status of the fan as “unhealthy”. Conversely, if the temperatures align with the expected patterns, the fan is marked as “healthy”.

In case, the health status of any of the one or more devices 106 is assigned as “unhealthy”, the ML model 210-a may be configured to perform fault determination and root cause analysis for the unhealthy device. In particular, the ML model 210-a may analyze the test results to identify specific faults or anomalies within the unhealthy device. Further, the ML model 210-a may identify underlying reasons for the occurrence of the fault.

After completing the fault determination and root cause analysis, the ML model 210-a may generate a comprehensive report detailing its findings. This report is a vital component of the overall process, as it consolidates the information about the identified faults and their potential causes into a format that can be easily reviewed by users.

In an embodiment, the ML model 210-a may notify a user associated with the unhealthy system about type of the fault and one or more reasons of fault occurrence either by displaying the report on the user interface 202 or by sending the report to a device associated with the user.

This communication ensures that users are aware of potential issues that could lead to device failures. By predicting early failures and providing actionable insights, the system 200 enhances the overall maintenance strategy, enabling users to take preventive measures before issues escalate.

In case, the health status of any of the one or more devices 106 may be assigned as “healthy”, the ML model 210-a may be configured to generate a report and notify the user about the healthy status of the healthy device. In an embodiment, the ML model 210-a may notify the user associated with the healthy device either by displaying the report on the user interface 202 or by sending the report to device associated with the user.

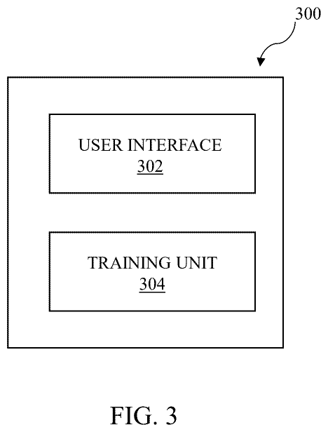

Moving towards FIG. 3 that illustrates a system (300) for facilitating training of ML model 112, in accordance with an embodiment of the present disclosure. The system 300 (same as the system 200 of FIG. 2) may constitute of a user interface 302 (same as the user interface 202 of FIG. 2) and a training unit 304. All the elements of the system 300 illustrated in FIG. 3 are essential elements, and the system 300 may be implemented by more elements than the constituent elements illustrated in FIG. 3, however the same are not explained for the sake of brevity. All the elements of the system 300 may communicate with each other via wireless connection, electric connection, or combination of both.

In an embodiment, the user interface 302 may obtain the historical data for training through a server (not shown in figs.) connected with the system 200.

In an embodiment, the ML model 112 may be same as the ML model 206-a. In an embodiment, the user interface 302 may obtain historical data related to assignment of the hardware configuration to each of the one or more devices 106 based on the SUT information and assignment of calibration and scaling factor to at least one parameter associated with the SUT information of the one or more devices. The user interface 302 may provide the historical data related to assignment of the hardware configuration and assignment of calibration and conversion factor, to the training unit 304. The training unit 304 may be configured to perform training of the assignment of the hardware configuration and assignment of calibration and conversion based on the historical data.

In an embodiment, the ML model 112 may be same as the ML model 208-a. In an embodiment, the user interface 302 may obtain historical data related to creation of the device classification, creation of test template, and identification of the test sequence. The user interface 302 may provide the historical data related to creation of the device classification, creation of test template, and identification of the test sequence, to the training unit 304. The training unit 304 may be configured to perform training of the creation of device classification, creation of test template, and identification of the test sequence based on the historical data.

In an embodiment, the ML model 112 may be same as the ML model 210-a. In an embodiment, the user interface 302 may receive historical data related to determining the health status of one or more devices 106 and notifying the health status of one or more devices 106. The user interface 302 may provide the historical data related to determining the health status of one or more devices 106 and notifying the health status of one or more devices, to the training unit 304. The training unit 304 may be configured to perform training of the determining the health status of one or more devices 106 and notifying the health status of one or more devices 106 based on the historical data.

In an embodiment, the each of the ML model 206-a, the ML model 208-a, and the ML model 210-a may be associated with same ML model 112.

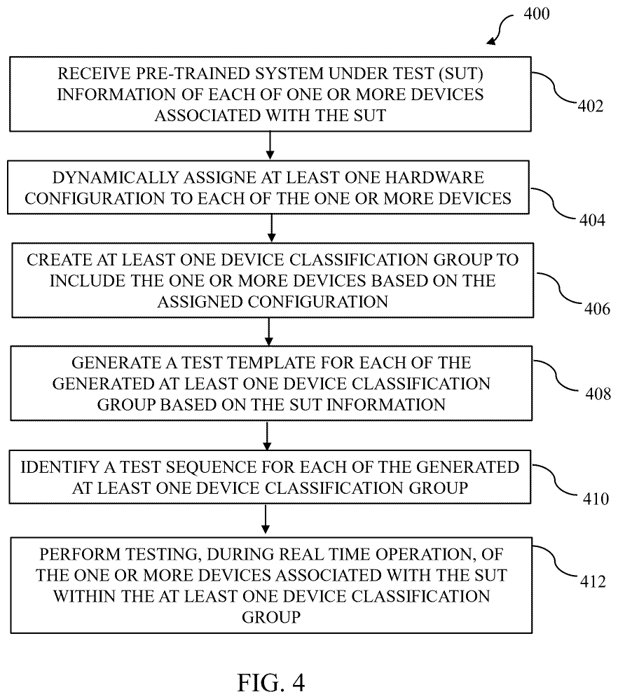

Moving towards FIG. 4 showing steps of a method 400 for facilitating testing of a System under Test (SUT), in accordance with an embodiment of the present disclosure. The method starts at step 402, at step 402 the method 400 may include receiving SUT information of each of one or more devices associated with the SUT. The SUT information may comprises component information and operational characteristics of the one or more devices. In an exemplary aspect, an user interface 202 of FIG. 2 of the system 200 may be configured to carry out the process steps disclosed in step 402.

At step 404, the method 400 may include dynamically assigning at least one hardware configuration to each of the one or more devices based on the SUT information. In order to assign the at least one hardware configuration, the method 400 may include comparing the SUT information with predefined information present in a dataset associated with the one or more devices and assigning at least one hardware configuration to each of the one or more devices based on the comparison. The predefined information present in the dataset includes the hardware component information, operational characteristics and one or more hardware configurations available for the one or more devices In an exemplary aspect, an assignment unit 206 of FIG. 2 of the system 200 may be configured to carry out the process steps disclosed in step 404.

At step 406, the method 400 may include creating at least one device classification group to include the one or more devices based on the assigned configuration. In an exemplary aspect, a generation unit 208 of FIG. 2 of the system 200 may be configured to carry out the process steps disclosed in step 406.

At step 408, the method 400 may include generating a test template for each of the generated at least one device classification group based on the SUT information. The test template include a sequence of operations to be performed on the one or more devices. In an exemplary aspect, the generation unit 208 may be configured to carry out the process steps disclosed in step 408.

At step 410, the method 400 may include identifying a test sequence for each of the generated at least one device classification group. The test sequence is indicative of an order in which testing on the generated at least one device classification group is to be performed. aspect, the generation unit 208 may be configured to carry out the process steps disclosed in step 410.

Finally, at step 412, the method may include performing testing, during real time operation, of the one or more devices associated with the SUT within the at least one device classification group based on the generated test template, identified test sequence, and the assigned hardware configuration to determine health status of the one or more devices. In order to determine the health status, the method 400 may include comparing the test results of the one or more devices with one or more prestored test patterns and determining the health status of the one or more devices based on the comparison. The one or more prestored test patterns are stored in a memory 212 of the system 200. if the test results of the one or more devices is not matching with the one or more prestored test patterns, the method 400 may include assigning the health status for the one or more devices as “unhealthy”, performing a fault determination and a root cause analysis for the one or more devices assigned with “unhealthy status”, generating a report based on the fault determination and the root cause analysis, and notifying a user about a type of fault determined and one or more reasons of fault occurrence to predict early failures of one or more devices associated with the SUT. if the test results of the one or more devices is matched with the one or more prestored test patterns, the method 400 may include assigning the health status for the one or more devices as “healthy” and generating a report based on the assigned health status for the one or more devices to notify the user about the one or more devices that are working in healthy state. In an exemplary aspect, a performing unit 210 of FIG. 2 of the system 200 may be configured to carry out the process steps disclosed in step 412.

In an embodiment, the method 400 may include assigning calibration and scaling factor to at least one parameter associated with the SUT information of the one or more devices and transforming the at least one parameter of the one or more devices by applying the calibration and scaling factor for the testing of respective one or more devices. The calibration and scaling factor enables transformation of the at least one parameter from one format to another format in order to accommodate scaling and calibration applied on the at least one parameter, wherein the assignment of calibration and scaling factor is dependent on the one or more devices associated with the SUT. In an exemplary aspect, the assignment unit 206 may be configured to carry out the process steps disclosed above.

The technical effects associated with the present disclosure as shown below:

An embodiment of the present disclosure may perform a process of autonomously assigning the hardware configuration which reduces the time required for manual configuration and minimizes the risk of human error.

An embodiment of the present disclosure may adapt to various testing configurations and dynamically adjust to changing requirements. This scalability allows for seamless integration of different SUTs without the need for extensive reconfiguration.

An embodiment of the present disclosure describes that the system have early failure prediction capability for identifying potential SUT issues. This early failure prediction capability of the system improves the reliability of SUT testing and reduces maintenance costs associated with unpredicted failures.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used herein, the term unit may be implemented in hardware and/or in software. If the unit is implemented in hardware, the unit may be configured as a device, e.g., as a computer or as a processor or as a part of a system, e.g., a computer system. If the unit is implemented in software, the unit may be configured as a computer program product, as a function, as a routine, or as a program code.

The hardware used to implement the various illustrative logics, logical blocks, modules, and circuits described in connection with the aspects disclosed herein may include a general purpose processor, a digital signal processor (DSP), a special-purpose processor such as an application specific integrated circuit (ASIC) or a field programmable gate array (FPGA), a programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively or additionally, some steps or methods may be performed by circuitry that is specific to a given function.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

What is claimed is:

1. A system for facilitating testing of a System under Test (SUT), comprising:
a user interface; and
a control unit communicably coupled with the user interface and configured to:
receive SUT information of each of one or more devices associated with the SUT, wherein the SUT information comprises component information and operational characteristics of the one or more devices; and
dynamically assign, by a pre-trained machine learning (ML) model, at least one hardware configuration to each of the one or more devices based on the SUT information;
create, by the pre-trained ML model, at least one device classification group to include the one or more devices based on the assigned configuration;
generate, by the pre-trained ML model, a test template for each of the generated at least one device classification group based on the SUT information, wherein the test template include a sequence of operations to be performed on the one or more devices;
identify, by the pre-trained ML model, a test sequence for each of the generated at least one device classification group, wherein the test sequence is indicative of an order in which testing on the generated at least one device classification group is to be performed; and
perform, by the pre-trained ML model, testing, during real time operation, on the one or more devices associated with the SUT within the at least one device classification group, based on the generated test template, identified test sequence, and the assigned hardware configuration to determine health status of the one or more devices.

2. The system of claim 1, wherein, to dynamically assign the at least one hardware configuration to each of the one or more devices, the control unit is configured to:
compare, by the pre-trained ML model, the SUT information with predefined information present in a dataset associated with the one or more devices, wherein the predefined information present in the dataset includes the hardware component information, operational characteristics, and one or more hardware configurations available for the one or more devices; and
assign, by the pre-trained ML model, at least one hardware configuration to each of the one or more devices based on the comparison.

3. The system of claim 1, wherein, to determine the health status of the one or more devices, the control unit is further configured to:
generate, by the pre-trained ML model, test results for the one or more devices based on the testing performed;
compare, by the pre-trained ML model, the test results of the one or more devices with one or more prestored test patterns, wherein the one or more prestored test patterns are stored in a memory of the system; and
determine, by the pre-trained ML model, the health status of the one or more devices based on the comparison.

4. The system of claim 3, wherein the control unit is further configured to:
if the test results of the one or more devices is not matching with the one or more prestored test patterns:
assign, by the pre-trained ML model, the health status for the one or more devices as “unhealthy”;
perform, by the pre-trained ML model, a fault determination and a root cause analysis for the one or more devices assigned with “unhealthy status”;
generate, by the pre-trained ML model, a report based on the fault determination and the root cause analysis; and
notify, by the pre-trained ML model, a user associated with the system about type of the fault and one or more reasons of fault occurrence to Predict Early failures of one or more devices associated with the SUT, and
if the test results of the one or more devices is matched with the one or more prestored test patterns:
assign, by the pre-trained ML model, the health status for the one or more devices as “healthy”; and
generate, by the pre-trained ML model, a report based on the assigned health status for the one or more devices to notify the user associated with the system about the one or more devices that are working in healthy state.

5. The system of claim 1, wherein the control unit is configured to:
assign, by the pre-trained ML model, calibration and scaling factor to at least one parameter associated with the SUT information of the one or more devices, wherein the calibration and scaling factor enables transformation of the at least one parameter from one format to another format in order to accommodate scaling and calibration applied on the at least one parameter, wherein the assignment of calibration and scaling is dependent on the one or more devices associated with the SUT; and
transform the at least one parameter of the one or more devices by applying the calibration and scaling factor for the testing of respective one or more devices.

6. A method for facilitating testing of a System under Test (SUT), comprising:
receiving SUT information of each of one or more devices associated with the SUT, wherein the SUT information comprises component information and operational characteristics of the one or more devices;
dynamically assigning at least one hardware configuration to each of the one or more devices based on the SUT information;
creating at least one device classification group to include the one or more devices based on the assigned configuration;
generating a test template for each of the generated at least one device classification group based on the SUT information, wherein the test template include a sequence of operations to be performed on the one or more devices;
identifying a test sequence for each of the generated at least one device classification group, wherein the test sequence is indicative of an order in which testing on the generated at least one device classification group is to be performed; and
performing testing, during real time operation, of the one or more devices associated with the SUT within the at least one device classification group based on the generated test template, identified test sequence, and the assigned hardware configuration to determine health status of the one or more devices.

7. The method of claim 6, further comprising:
comparing the SUT information with predefined information present in a dataset associated with the one or more devices, wherein the predefined information present in the dataset includes the hardware component information, operational characteristics and one or more hardware configurations available for the one or more devices; and
assigning at least one hardware configuration to each of the one or more devices based on the comparison.

8. The method of claim 6, further comprising:
generating test results for one or more devices based on the testing performed;
comparing the test results of the one or more devices with one or more prestored test patterns, wherein the one or more prestored test patterns are stored in a memory of the system; and
determining the health status of the one or more devices based on the comparison.

9. The method of claim 8, further comprising:
if the test results of the one or more devices is not matching with the one or more prestored test patterns:
assigning the health status for the one or more devices as “unhealthy”;
performing a fault determination and a root cause analysis for the one or more devices assigned with “unhealthy status”;
generating a report based on the fault determination and the root cause analysis; and
notifying a user about a type of fault determined and one or more reasons of fault occurrence to predict early failures of one or more devices associated with the SUT; and
if the test results of the one or more devices is matched with the one or more prestored test patterns:
assigning the health status for the one or more devices as “healthy” and
generating a report based on the assigned health status for the one or more devices to notify the user about the one or more devices that are working in healthy state.

10. The method of claim 6, further comprising:
assigning calibration and scaling factor to at least one parameter associated with the SUT information of the one or more devices, wherein the calibration and scaling factor enables transformation of the at least one parameter from one format to another format in order to accommodate scaling and calibration applied on the at least one parameter, wherein the assignment of calibration and scaling factor is dependent on the one or more devices associated with the SUT; and
transforming the at least one parameter of the one or more devices by applying the calibration and scaling factor for the testing of respective one or more devices.

11. A non-transitory computer-readable medium storing computer-executable instructions for facilitating testing of a System under Test (SUT), the computer-executable instructions configured for:
receiving SUT information of each of one or more devices associated with the SUT, wherein the SUT information comprises component information and operational characteristics of the one or more devices;
dynamically assigning at least one hardware configuration to each of the one or more devices based on the SUT information;
creating at least one device classification group to include the one or more devices based on the assigned configuration;
generating a test template for each of the generated at least one device classification group based on the SUT information, wherein the test template include a sequence of operations to be performed on the one or more devices;
identifying a test sequence for each of the generated at least one device classification group, wherein the test sequence is indicative of an order in which testing on the generated at least one device classification group is to be performed; and
performing testing, during real time operation, of the one or more devices associated with the SUT within the at least one device classification group based on the generated test template, identified test sequence, and the assigned hardware configuration to determine health status of the one or more devices.

12. The non-transitory computer-readable medium of claim 11, wherein the computer-executable instructions are configured for:
comparing the SUT information with predefined information present in a dataset associated with the one or more devices, wherein the predefined information present in the dataset includes the hardware component information, operational characteristics and one or more hardware configurations available for the one or more devices; and
assigning at least one hardware configuration to each of the one or more devices based on the comparison.

13. The non-transitory computer-readable medium of claim 11, wherein the computer-executable instructions are configured for:
generating test results for one or more devices based on the testing performed;
comparing the test results of the one or more devices with one or more prestored test patterns, wherein the one or more prestored test patterns are stored in a memory of the system; and
determining the health status of the one or more devices based on the comparison.

14. The non-transitory computer-readable medium of claim 11, wherein the computer-executable instructions are configured for:
if the test results of the one or more devices is not matching with the one or more prestored test patterns:
assigning the health status for the one or more devices as “unhealthy”;
performing a fault determination and a root cause analysis for the one or more devices assigned with “unhealthy status”;
generating a report based on the fault determination and the root cause analysis; and
notifying a user about a type of fault determined and one or more reasons of fault occurrence to predict early failures of one or more devices associated with the SUT; and
if the test results of the one or more devices is matched with the one or more prestored test patterns:
assigning the health status for the one or more devices as “healthy” and generating a report based on the assigned health status for the one or more devices to notify the user about the one or more devices that are working in healthy state.

15. The non-transitory computer-readable medium of claim 11, wherein the computer-executable instructions are configured for:
assigning calibration and scaling factor to at least one parameter associated with the SUT information of the one or more devices, wherein the calibration and scaling factor enables transformation of the at least one parameter from one format to another format in order to accommodate scaling and calibration applied on the at least one parameter, wherein the assignment of calibration and scaling factor is dependent on the one or more devices associated with the SUT; and
transforming the at least one parameter of the one or more devices by applying the calibration and scaling factor for the testing of respective one or more devices.
